(19) United States
(12) Patent Application Publication
(10) Pub. No.: US 2010/0094466 A1
(43) Pub. Date: Apr. 15, 2010

(54) INTEGRATED QUIET AND ENERGY EFFICIENT MODES OF OPERATION FOR AIR-COOLED CONDENSER

(75) Inventors: John Judge, Galena, OH (US); Wanlai Lin, Dublin, OH (US)

Correspondence Address: HARNESS, DICKEY & PIERCE, P.L.C., P.O. BOX 828, BLOOMFIELD HILLS, MI, 48303, US

(73) Assignee: Libert Corporation, Columbus, OH (US)

(21) Appl. No.: 12/560,066

(22) Filed: Sep. 15, 2009

Related U.S. Application Data
(60) Provisional application No. 61/105,176, filed on Oct. 14, 2008.

(51) Int. Cl. G05B 15/00

(52) U.S. Cl. 700/275

(57) ABSTRACT

An integrated quiet and energy efficient modes of operation for an air-cooled condenser according to the present disclosure can allow a user to select operation along a continuum that extends from a relatively more efficient mode of operation to a relatively more quiet mode of operation. The user-selected mode allows a user to select a compromise between efficient operation and quiet operation so that a desired operation of a cooling system having the air-cooled condenser is realized. The speed of a fan which induces an airflow across a condenser can be adjusted based on the user-selected operating mode.

### CROSS-REFERENCE TO RELATED APPLICATIONS

This application claims the benefit of U.S. Provisional Application No. 61/105,176, filed on Oct. 14, 2008. The entire disclosure of the above application is incorporated herein by reference.

### FIELD

The present disclosure relates to operation of cooling systems and, in particular, cooling systems utilizing an air-cooled condenser.

### BACKGROUND

This section provides background information related to the present disclosure which is not necessarily prior art.

Cooling systems, such as the type that utilize a vapor compression cycle, can include a compressor, a condenser, an expansion device, and an evaporator. The compressor is operable to condense a working fluid from a suction pressure to a discharge pressure which is supplied to a condenser. In the condenser, heat is removed from the working fluid while the working fluid is at an elevated pressure. The working fluid flows from the condenser through an expansion device wherein the pressure is reduced. From there, the working fluid flows through an evaporator wherein heat is added and the temperature of the working fluid increased. The working fluid flows from the evaporator to the compressor and the process begins again.

The condenser may be an air-cooled condenser wherein a fan can be utilized to supply a flow of air over the condenser to facilitate the removal of heat from the working fluid flowing therethrough. In these types of cooling systems, the current control methodology involves the maintaining of the condensing pressure (the pressure of the working fluid at/in the condenser) at a fixed and elevated value to allow the expansion valve to function properly. The fixed condensing pressure is a minimum condensing pressure. For example, the condensing pressure can be maintained at or above approximately 220 PSIG when R407C is utilized as a working fluid, by way of non-limiting example. The condensing pressure can be maintained at or above the fixed elevated value by adjusting the operation of the condenser. For example, the speed of the fan that supplies the airflow through the condenser can be adjusted to maintain the fixed elevated condensing pressure with a variable frequency drive or a fan speed control. The condensing pressure can also be maintained at or above the fixed elevated value by adjusting inlet vanes, head pressure control valves, or other means to reduce the effectiveness of the air-cooled condenser.

These modes of operation, however, can waste compressor energy (decrease efficiency), especially during cooler ambient conditions, by maintaining the condensing pressure at a higher value than needed to meet the cooling load. Additionally, when the fan speed for the air-cooled condenser is increased to maintain the minimum condensing pressure, the noise generated by the fan can be excessive. The excessive noise may require the use of additional sound insulating or deadening materials to maintain the noise at an acceptable level.

Thus, it would be advantageous to provide a method of operating a cooling system utilizing an air-cooled condenser that can reduce the waste of compressor energy (increase efficiency) and/or reduce the noise generated by the cooling system. It would be further advantageous if the method allowed a flexible approach that can balance the needs for efficiency versus the desire for quiet operation.

### SUMMARY

Further areas of applicability will become apparent from the description provided herein. The description and specific examples in this summary are intended for purposes of illustration only and are not intended to limit the scope of the present disclosure.

An integrated quiet and energy efficient modes of operation for an air-cooled condenser according to the present disclosure can allow a user to select operation along a continuum that extends from a relatively more efficient mode of operation to a relatively more quiet mode of operation. The user-selected mode allows a user to select a compromise between efficient operation and quiet operation so that a desired operation of a cooling system having the air-cooled condenser is realized.

A method of operating a cooling system utilizing a vapor compression cycle and having a condenser that is cooled by a fan-induced airflow according to the present disclosure includes ascertaining a user-selected operating mode along a continuum between an efficient mode of operation and a quiet mode of operation. The efficient mode of operation corresponds to operation of the cooling system at a greater efficiency relative to the quiet mode. The quiet mode of operation corresponds to operation of the cooling system at a lower sound level relative to the efficient mode. The method includes adjusting a speed of the fan based on the user-selected operating mode.

In some aspects, the adjusting of the speed of the fan may include increasing the speed of the fan when a relatively more efficient mode of operation is selected and decreasing the speed of the fan when a relatively more quiet mode of operation is selected. The adjusting of the speed of the fan may be based on the user-selected operating mode along the continuum and may be based on a cooling demand placed on an evaporator of the cooling system. An ambient temperature of the fan-induced airflow may be utilized when determining the adjustment to the speed of the fan. The condensing pressure of the working fluid may be determined and utilized when adjusting the speed of the fan. A condensing pressure set point required to meet a cooling demand placed on the evaporator may be ascertained and the speed of the fan may be adjusted to maintain the condensing pressure greater than or equal to the condensing pressure set point. The speed of the fan may be adjusted such that the cooling system operates at a condensing pressure closer to the required condensing pressure as the user-selected operating mode approaches the quiet mode end of the continuum. The speed of the fan may be adjusted such that the cooling system operates at a condensing pressure farther away from the required condensing pressure toward a maximum condensing pressure as the user-selected operating mode approaches the efficient mode end of the continuum.

In some aspects, the speed of the fan may be adjusted so that the cooling system operates at a condensing pressure equal to or slightly greater than a minimum required condensing pressure to meet a cooling load placed on the evaporator of the cooling system when the user-selected operating mode is at the efficient mode end of the continuum. In other aspects, the speed of the fan may be adjusted so that the cooling system operates at a condensing pressure equal to or slightly less than a maximum condensing pressure when the user-selected operating mode is at the quiet mode end of the continuum.

A cooling system control system according to the present disclosure includes a cooling system that has a condenser that is cooled by fan-induced airflow and has a working fluid flowing therethrough. There is a user input device that includes a user-selectable operation mode along a continuum between an efficient mode of operation and a quiet mode of operation. The efficient mode of operation corresponds to operation of the cooling system at a greater efficiency relative to the quiet mode and the quiet mode of operation corresponds to operation of the cooling system at a lower sound level relative to the efficient mode. A control commands operation of the fan at varying speeds based on the user-selected operating mode.

### DRAWINGS

The drawings described herein are for illustrative purposes only of selected embodiments and not all possible implementations, and are not intended to limit the scope of the present disclosure.

FIG. 1 is a schematic representation of a cooling system utilizing an air-cooled condenser in which an integrated quiet and energy efficient mode of operation according to the present disclosure can be utilized;

FIG. 2 is a schematic representation of a control system that could be used to implement the integrated quiet and energy efficient mode of operation according to the present disclosure to control the cooling system of FIG. 1;

FIG. 3 is a representation of a user input panel; and

FIG. 4 is a theoretical representative graph of the changing in energy consumption and sound production as a function of condensing pressure.

Corresponding reference numerals indicate corresponding parts throughout the several views of the drawings.

### DETAILED DESCRIPTION

Example embodiments will now be described more fully with reference to the accompanying drawings. As used herein, the term “module” refers to an application-specific integrated circuit (ASIC), an electronic circuit, a processor (shared, dedicated, or group), and memory that execute one or more software or firmware programs, a combinational logic circuit, or other suitable components that provide the described functionality.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

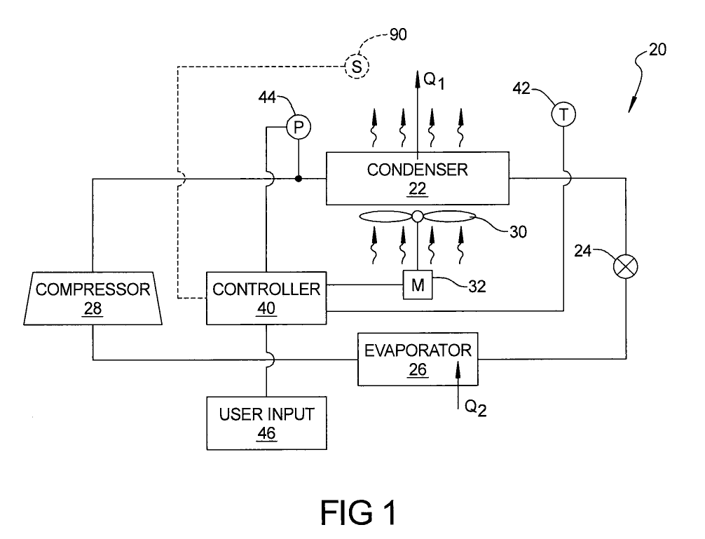

Referring to FIG. 1, a cooling system 20 that can be operated using the integrated quiet and energy efficient mode of operation according to the present disclosure is shown. Cooling system 20 includes an air-cooled condenser 22, an expansion device 24, an evaporator 26, and a compressor 28. Compressor 28 is operable to condense a working fluid from a suction pressure to a discharge pressure. The working fluid exits compressor 28 and flows through condenser 22, expansion device 24, and evaporator 26 and returns to compressor 28. Within condenser 22, heat Q₁ is removed from the working fluid by an airflow flowing across condenser 22. The airflow is provided by a fan 30 powered by a motor 32. The pressure of the working fluid is reduced as the working fluid passes across expansion device 24. Within evaporator 26, heat Q₂ is transferred to the working fluid flowing therethrough. The above-described cooling system 20 is a typical cooling system known to one skilled in the art.

A controller 40 can be utilized with cooling system 20. Controller 40 includes one or more modules, as needed, to control the operation of cooling system 20 in accordance with the integrated quiet and energy efficient modes of operation of the present disclosure. Controller 40 can receive a signal from a temperature sensor 42 that is indicative of the ambient temperature of the airflow that is supplied to condenser 22 by fan 30. A pressure sensor 44 can supply a signal to controller 40 that is indicative of the condensing pressure in cooling system 20. Controller 40 can also receive a user input signal 46 that is indicative of a desired operational mode for cooling system 20, as described below. Controller 40 communicates with motor 32 and is operable to command a desired operation of motor 32 and fan 30. Additionally, controller 40 can receive a signal 48 from a sensor that is indicative of the speed of motor 32 and thereby the speed of fan 30.

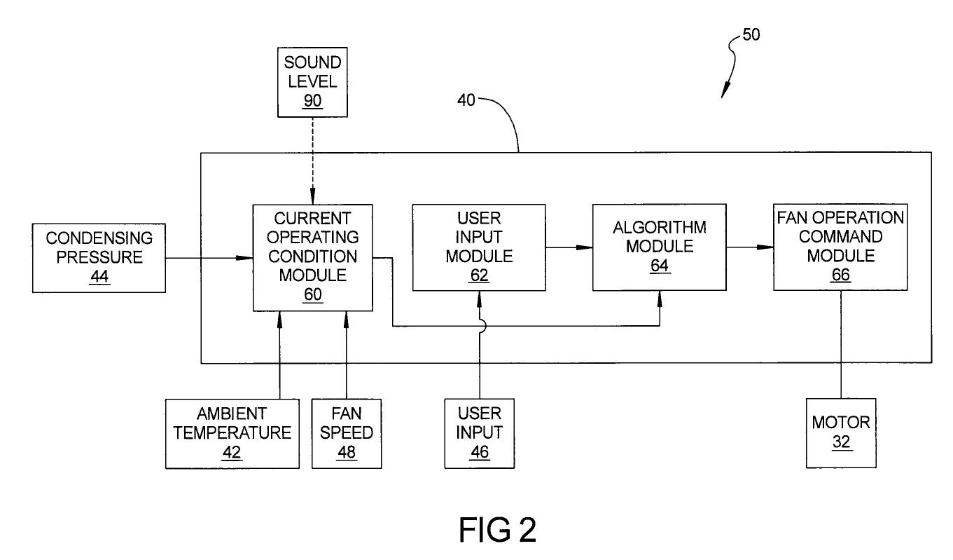

Referring now to FIG. 2, an exemplary control system 50 that can implement the integrated quiet and energy efficient mode of operation according to the present disclosure is shown. Control system 50 utilizes controller 40 which is operable to control a desired operation of fan 30 (via motor 32) in accordance with the integrated quiet and energy efficient modes of operation according to the present disclosure. Controller 40 can be a single module operable to perform the described functionality, a plurality of integrated modules, as shown, that can perform the described functionality, a combination of integrated and individual modules that can perform the described functionality, and/or one or more individual modules that can perform the described functionality. Thus, controller 40 shown and described herein is merely exemplary in nature and is not intended to limit the scope of the present disclosure.

As stated above, controller 40 can include a plurality of integrated modules that perform the described functionality. By way of non-limiting example, controller 40 can include a current operating condition module 60, a user input module 62, an algorithm module 64, and a fan operation command module 66. Current operating condition module 60 receives a signal indicative of the ambient temperature from temperature sensor 42, a signal indicative of the condensing pressure from pressure sensor 44, and a signal 48 indicative of the speed (RPM) of fan 30. Current operating condition module 60 monitors these various signals and supplies the values of the signals to algorithm module 64.

User input module 62 receives user input signal 46 which is indicative of a desired operational condition for cooling system 20. User input module 62 monitors user input signal 46 and supplies a signal indicative of the desired operation to algorithm module 64.

Algorithm module 64 is operable to utilize the signal from user input module 62 and the current operating conditions provided by current operating condition module 60 to provide a signal to fan operation command module 66 that is indicative of a desired operation of fan 30. Fan operation command module 66 commands operation of motor 32 to thereby achieve a desired operational condition for fan 30 based on the signal received from algorithm module 64.

In cooling system 20, an increase in the speed of fan 30 will increase the airflow rate through condenser 22, which increases the heat rejection capability of condenser 22. An increased heat rejection capacity in condenser 22 can reduce the condensing temperature and pressure of the working fluid flowing through cooling system 20. A lower condensing temperature and pressure in cooling system 20 leads to higher system efficiency. Thus, a higher fan speed can result in an increase in the efficiency of cooling system 20. The higher fan speed, however, generates a higher noise for cooling system 20. On the other hand, a lower speed of fan 30 will decrease the noise generated. The lower fan speed, however, reduces the ventilation airflow rate, which will reduce the heat rejection capability of condenser 22. Lower heat rejection of condenser 22 leads to an increase of the condensing temperature and pressure of the working fluid, which leads to a lower efficiency for cooling system 20. Therefore, fan 30 can be operated at a higher speed to increase the efficiency of cooling system 20 at the expense of greater noise generation or can be operated at a lower speed to decrease the noise generated at the expense of reduced efficiency of cooling system 20.

The integrated quiet and energy efficient modes of operation according the present disclosure allow a balance between these competing interests and results. The integrated quiet and energy efficient modes of operation according to the present disclosure utilized by control system 50 is a unique control method which allows a continuum of operating modes between an energy efficient mode of operation and a quiet mode of operation. The control system 50 and the methodology of the integrated quiet and energy efficient modes of operation make use of three related observations: (1) it is possible to save energy by reducing condensing pressure; (2) it is possible to reduce noise by increasing condensing pressure; and (3) it is possible and desirable for a building owner/user to decide where along this continuum he or she would like to operate.

The noise generated by condenser 22 is proportional to the speed of fan 30. The fan power is proportional to the cubic power of the fan speed. The noise level (sound power) of fan 30 is a logarithm function of fan speed. Thus, small changes in the speed of fan 30 can have a marked impact on noise. The integrated quiet and energy efficient modes of operation recognize that it is possible to reduce the noise of condenser 22 by reducing the speed of fan 30. The required speed of fan 30 is related to the condensing pressure set point. Specifically, the speed of fan 30 can be adjusted to achieve or maintain the condensing pressure set point. A reduction in the speed of fan 30 can be effected by increasing the condensing pressure set point which thereby reduces the required speed of fan 30 to achieve or maintain the increased condensing pressure set point which in turn can dramatically reduce noise.

Linking efficiency and noise attenuation (or sound) together is a common variable—condensing pressure. The integrated quiet and energy efficient modes of operation according to the present disclosure and utilized by control system 50 allows end users to determine what level of efficiency or sound attenuation they desire by providing a means to indirectly modify the condensing pressure set point. Further, the efficiency/noise setting selected by the end users can be static or dynamic. Specifically, there can be different settings that are selectable by the user and the settings can be applicable for different times of the day, days of the week, or days of the year. These settings can also be configured to comply with local noise ordinances.

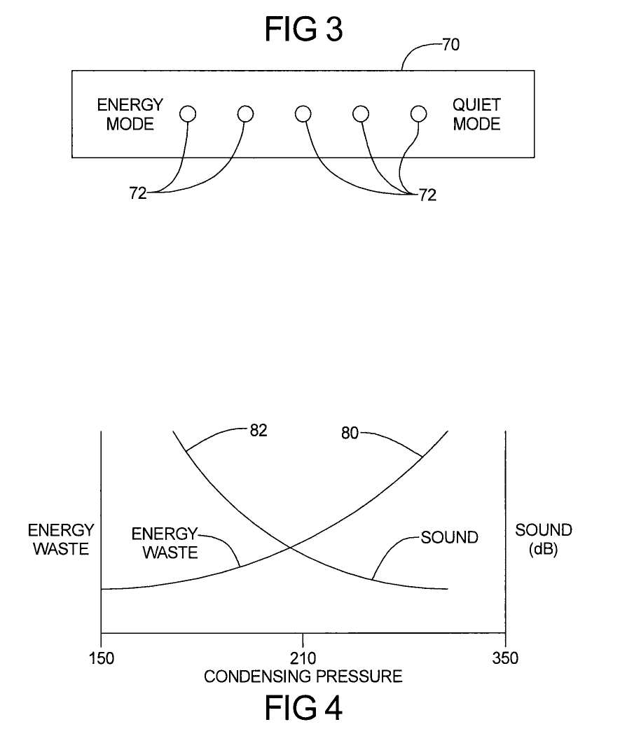

As shown in FIG. 3, a user interface can include a control or display panel 70 that can include a plurality of indicators 72 that can extend along control panel 70. Indicia can be provided on the opposite sides of indicator 72. For example, as shown in control panel 70, the indicia “Energy Mode” can be located on one side of indicator 72 while the indicia “Quiet Mode” can be located on the other side of indicator 72. In control panel 70 shown in FIG. 3, there are five indicators 72. Indicators 72 can be visual indicators that convey to the user where along the continuum between the energy mode and the quiet mode cooling system 20 is currently operating. In some embodiments, indicators 72 can also be functional input devices wherein the user can press or activate any one of indicators 72 to achieve operation of cooling system 20 in that particular location along the continuum between the energy mode and the quiet mode. In other embodiments, a different user input device may be utilized to change the operating mode of cooling system 20 along the continuum between the energy mode and the quiet mode.

The integrated quiet and energy efficient modes of operation utilized by control system 50 according to the present disclosure allow a user to select the desired operating condition along the continuum between the energy mode and the quiet mode. The selection would correspond to changing the allowable condensing pressure (the condensing pressure set point) at which cooling system 20 can operate. The allowable condensing pressure (condensing pressure set point) would be a maximum condensing pressure. The particular maximum allowable condensing pressure is function of the specific working fluid utilized and can be different for different working fluids.

Control system 50 maintains operation at or below that condensing pressure set point while adjusting the speed of fan 30, as necessary, to meet the cooling demands placed on cooling system 20. Specifically, algorithm module 64 utilizes the signal from user input module 62 along with the signals from current operating condition module 60 to ascertain the appropriate speed of fan 30 to maintain the condensing pressure at or below the maximum allowable condensing pressure (the condensing pressure set point) while achieving the desired level of noise attenuation. The algorithm module 64 uses algorithms to ascertain the appropriate speed for fan 30 based on the desired operation, as provided by user input module 62, and the current operating conditions as provided by current operating condition module 60.

When the most quiet mode of operation is desired, the algorithm will reduce the speed of fan 30 while allowing the condensing pressure to increase up to the maximum allowable condensing pressure. This operation, however, can reduce the efficiency of cooling system 20. When most efficient operation is requested (the energy mode), the algorithm will provide the highest speed for fan 30 thereby decreasing the condensing pressure and increasing the efficiency of cooling system 20. Between these two extremes, is the continuum within which the algorithm will operate to balance the user's desire for quiet operation versus energy efficient operation. As such, when some intermediate operation is selected along the continuum between the energy mode and the quiet mode, algorithm module 64 ascertains an appropriate speed for fan 30 that provides for quieter operation while also taking into consideration the effect on the system efficiency of cooling system 20.

Thus, when a user desires a more quiet mode of operation, algorithm module 64 can provide signals to fan operation command module 66 that adjusts the operation of motor 32 and thereby changes the speed of fan 30. The user can dynamically change the current operation of cooling system 20 by inputting a request for operation at differing locations along the continuum. Alternatively, as described above, control system 50 can be pre-programmed to change the operation of cooling system 20 along the continuum based on such things as the times of day, the days of the week, or the particular days in the year, by way of non-limiting example. Additionally, the algorithm takes into account the current condensing pressure, the current ambient temperature, and the current fan speed when ascertaining the appropriate speed for fan 30 to operate in a desired mode as requested by the user input.

Referring now to FIG. 4, an exemplary theoretical graph illustrates the balancing/tradeoff in operating along the continuum. Along the horizontal axis are varying representative condensing pressures that may be achieved in cooling system 20. Curve 80 is representative of the energy consumption of cooling system 20 as a function of changing condensing pressure, while curve 82 is representative of the sound level as a function of varying condensing pressure. As can be seen, operating at a higher condensing pressure can reduce the sound level due to a decrease in the required speed of fan 30. At the same time, however, the increasing condensing pressure results in additional energy consumption by cooling system 20 and results in less energy efficient operation. In contrast, by adjusting the condensing pressure to a lower value, the sound level increases due to the need to provide additional ventilation airflow across condenser 22 (higher fan speed) to achieve the lower condensing pressure. This operation also results in more efficient operation of cooling system 20 and a reduction in the waste energy (increased efficiency). As such, it can be seen that by adjusting the condensing pressure a tradeoff can be made between the sound level and the energy wasted (efficiency) in cooling system 20.

Thus, the integrated quiet and energy efficient modes of operation according to the present disclosure utilize a unique methodology that allows a continuum of operations between an energy efficient mode of operation and a quiet mode of operation. The method allows the end-users to determine what level of efficiency or sound attenuation they desire by inputting the request that is utilized by the algorithm. The algorithm then ascertains an appropriate speed for fan 30 to achieve the user requested operating state. The algorithm chooses the appropriate operating state while maintaining the condensing pressure at or below a maximum allowable condensing pressure. This is in direct contrast to the current control methodology wherein a minimum condensing pressure is maintained.

A control algorithm ascertains the appropriate condensing pressure (equal to or below a maximum condensing pressure) based on the user input and ambient conditions and ascertains the appropriate speed of fan 30 to achieve this. The actual condensing pressure will vary as the desired operation of cooling system 20 is adjusted by user input between the energy efficient mode and the quiet mode of operation. As a result, cooling system 20 is not operated with a constant condensing pressure. Rather, the condensing pressure is varied depending upon the desired efficient operation and desired sound level for cooling system 20. The speed of fan 30 is adjusted to achieve the appropriate condensing pressure as determined by the algorithm while being at or below a maximum condensing pressure.

It should be appreciated that the maximum allowed condensing pressure will be a function of the type of working fluid utilized in cooling system 20. As such, cooling systems with differing working fluids therein will have differing allowable ranges of condensing pressure with which the cooling system can operate.

Cooling system 20 and control system 50 which implement the integrated quiet and energy efficient modes of operation according to the present disclosure can be utilized to cool buildings, data centers, computer rooms, and the like. Additionally, they can be utilized in situations wherein the cooling is critical, such as applications that require precise conditioning of the environment 24 hours per day, 7 days a week, and 365 days a year.

In some embodiments, control system 50 can also utilize a sound sensor 90 that is operable to provide a signal through current operating condition module 60 that is indicative of the current noise level being produced by cooling system 20. When this is the case, the algorithm utilized by algorithm module 64 can adjust the speed of fan 30 to ensure that the noise level is at all times below a certain predetermined level so long as the condensing pressure does not exceed the allowable maximum condensing pressure.

It should be appreciated that while pressure sensor 44 of cooling system 20 is shown as reading a pressure of the working fluid prior to flowing into condenser 22, the term “condensing pressure” as used herein is not to be limited to the pressure of the working fluid prior to entering into condenser 22. Rather, the condensing pressure can be the pressure of the working fluid at the inlet to condenser 22, at the outlet of condenser 22, an average of the inlet and outlet pressures, a midpoint pressure between the inlet and outlets of condenser 22, or at some other location within condenser 22. The particular location(s) for measuring the pressure and determining the condensing pressure can vary depending upon the design of cooling system 20, the type of working fluid utilized therein, the specific configuration of condenser 22, and the like by way of non-limiting example. Thus, the term “condensing pressure” as used herein is to be construed as being a pressure indicative of the working fluid as it relates in some aspect to condenser 22 and/or the operation of same.

It should be appreciated that while the airflow across condenser 22 is shown as being induced by a fan, it should be appreciated that other types of variable-speed devices can be utilized to induce the airflow across condenser 22. For example, fan 30 can be replaced with a blower and the like, by way of non-limiting example. Therefore, it should be appreciated that while the terms “fan” and “fan-induced” are used in the specification and claims, such terminology is to be construed as including other types of air-moving devices such as blowers and the like used to induce an airflow across a condenser.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method of operating a cooling system utilizing a vapor compression cycle and having a condenser that is cooled by a fan-induced airflow, the method comprising:
ascertaining a user-selected operating mode along a continuum between an efficient mode of operation and a quiet mode of operation, the efficient mode of operation corresponding to operation of the cooling system at a greater efficiency relative to the quiet mode and the quiet mode of operation corresponding to operation of the cooling system at a lower sound level relative to the efficient mode; and
adjusting a speed of the fan based on the user-selected operating mode.

2. The method of claim 1, further comprising maintaining a condensing pressure of the working fluid at or below a maximum condensing pressure.

3. The method of claim 2, wherein adjusting the speed of the fan includes increasing the speed of the fan when a relatively more efficient mode of operation is selected and decreasing the speed of the fan when a relatively more quiet mode of operation is selected.

4. The method of claim 2, wherein adjusting the speed of the fan alters the condensing pressure of the cooling system.

5. The method of claim 2, wherein adjusting the speed of the fan includes adjusting the speed of the fan based on the user-selected operating mode along the continuum and a cooling demand placed on an evaporator of the cooling system.

6. The method of claim 5, wherein for a constant cooling demand placed on the evaporator of the cooling system adjusting the speed of the fan includes increasing the speed of the fan as the user selects operation along the continuum more toward the efficient mode and decreasing the speed of the fan as the user selects operation along the continuum more toward the quiet mode.

7. The method of claim 5, further comprising ascertaining an ambient temperature of the fan-induced airflow and wherein adjusting the speed of the fan further includes adjusting the speed of the fan based on the ascertained ambient temperature.

8. The method of claim 7, further comprising ascertaining the condensing pressure of the cooling system and wherein adjusting the speed of the fan further includes adjusting the speed of the fan based on the ascertained condensing pressure.

9. The method of claim 8, further comprising ascertaining a condensing pressure set point required to meet the cooling demand placed on the evaporator and wherein adjusting the speed of the fan includes maintaining the condensing pressure greater than or equal to the condensing pressure set point.

10. The method of claim 1, further comprising ascertaining a required condensing pressure to meet a cooling demand placed on an evaporator of the cooling system and wherein adjusting the speed of the fan includes adjusting the speed of the fan such that the cooling system operates at a condensing pressure closer to the required condensing pressure as the user-selected operating mode approaches the efficient mode end of the continuum and such that the cooling system operates at a condensing pressure farther away from the required condensing pressure toward a maximum condensing pressure as the user-selected operating mode approaches the quiet mode end of the continuum.

11. The method of claim 1, wherein adjusting the speed of the fan includes adjusting the speed of the fan so that the cooling system operates at a condensing pressure equal to or slightly greater than a minimum required condensing pressure to meet a cooling load placed on an evaporator of the cooling system when the user-selected operating mode is at the efficient mode end of the continuum.

12. The method of claim 1, wherein adjusting the speed of the fan includes adjusting the speed of the fan so that the cooling system operates at a condensing pressure equal to or slightly less than a maximum condensing pressure when the user-selected operating mode is at the quiet mode end of the continuum.

13. A cooling system control system comprising:
a cooling system that includes a condenser that is cooled by a fan-induced airflow and has a working fluid flowing therethrough;
a user input device that includes a user-selectable operation mode along a continuum between an efficient mode of operation and a quiet mode of operation, the efficient mode of operation corresponding to operation of the cooling system at a greater efficiency relative to the quiet mode and the quiet mode of operation corresponding to operation of the cooling system at a lower sound level relative to the efficient mode; and
a control that commands operation of the fan at varying speeds based on the user-selected operating mode.

14. The cooling system control system of claim 13, wherein the control ascertains a condensing pressure of the working fluid and commands operation of the fan to maintain the condensing pressure at or below a maximum condensing pressure.

15. The cooling system control system of claim 14, wherein the control commands an increase in the fan speed when a relatively more efficient mode of operation is selected and commands a decrease in the fan speed when a relatively more quiet mode of operation is selected.

16. The cooling system control system of claim 13, wherein the cooling system includes an evaporator and the control commands adjustment to the fan speed based on the user-selected operating mode along the continuum and a cooling demand placed on the evaporator.

17. The cooling system control system of claim 16, wherein for a constant cooling demand placed on the evaporator the control commands an increase in the fan speed as the user selects operation along the continuum more toward the efficient mode and commands a decrease in the fan speed as the user selects operation along the continuum more toward the quiet mode.

18. The cooling system control system of claim 16, wherein the control ascertains an ambient temperature of the fan-induced airflow and commands adjustments to the fan speed based on the ascertained ambient temperature.

19. The cooling system control system of claim 16, wherein the control ascertains a condensing pressure of the working fluid and commands adjustment to the fan speed based on the ascertained condensing pressure.

20. The cooling system control system of claim 19, wherein the control ascertains a condensing pressure set point required to meet the cooling demand placed on the evaporator and the control commands adjustment to the fan speed to maintain the condensing pressure greater than or equal to the condensing pressure set point.

21. The cooling system control system of claim 13, wherein the cooling system includes an evaporator and control ascertains a required condensing pressure to meet a cooling demand placed on the evaporator and commands adjustment to the fan speed such that the cooling system operates at a condensing pressure closer to the required condensing pressure as the user-selected operating mode approaches the efficient mode end of the continuum and such that the cooling system operates at a condensing pressure farther away from the required condensing pressure toward a maximum condensing pressure as the user-selected operating mode approaches the quiet mode end of the continuum.

22. The cooling system control system of claim 13, wherein the cooling system includes an evaporator and the control commands adjustment in the fan speed so that the cooling system operates at a condensing pressure equal to or slightly greater than a minimum required condensing pressure to meet a cooling load placed on the evaporator when the user-selected operating mode is at the efficient mode end of the continuum.

23. The cooling system control system of claim 13, wherein the control commands adjustment in the fan speed so that the cooling system operates at a condensing pressure equal to or slightly less than a maximum condensing pressure when the user-selected operating mode is at the quiet mode end of the continuum.
